(19) United States
(12) Patent Application Publication
(10) Pub. No.: US 2024/0394333 A1
(43) Pub. Date: Nov. 28, 2024

(54) HYBRID CHANNEL MODELING FOR TIME SERIES FOUNDATION MODELS

(71) Applicant: INTERNATIONAL BUSINESS MACHINES CORPORATION, Armonk, NY (US)

(72) Inventors: Vijay Ekambaram, Chennai (IN); Arindam Jati, Bengaluru (IN); Nam H. Nguyen, Pleasantville, NY (US); Phanwadee Sinthong, White Plains, NY (US); Jayant R. Kalagnanam, Briarcliff Manor, NY (US)

(21) Appl. No.: 18/200,640

(22) Filed: May 23, 2023

(51) Int. Cl. G06F 17/18

(52) U.S. Cl. CPC G06F 17/18

(57) ABSTRACT

A method, system, and compute program product are configured to: receive a dataset comprising a multivariate time series that includes plural channels; generate an original forecast of the multivariate time series using a channel-independent backbone and a prediction head; and generate a revised forecast of the multivariate time series using a cross-channel reconciliation head with the original forecast, wherein the cross-channel reconciliation head generates the revised forecast based on correlations between the channels of the multivariate time series.

### BACKGROUND

Aspects of the present invention relate generally to time series forecasting using artificial intelligence models and, more particularly, to hybrid channel modeling for time series foundation models.

Time series forecasting is the process of analyzing time series data using statistics and modeling to make predictions about future values of the time series. Time series forecasting can be performed using a foundation model (also called base model), which is a large artificial intelligence (AI) model trained on a vast quantity of data at scale (often by self-supervised learning or semi-supervised learning) resulting in a model that can be adapted to a wide range of downstream tasks.

### SUMMARY

In a first aspect of the invention, there is a computer-implemented method including: receiving, by a processor set, a dataset comprising a multivariate time series that includes plural channels; generating, by the processor set, an original forecast of the multivariate time series using a channel-independent backbone and a prediction head; and generating, by the processor set, a revised forecast of the multivariate time series using a cross-channel reconciliation head with the original forecast, wherein the cross-channel reconciliation head generates the revised forecast based on correlations between the channels of the multivariate time series.

In another aspect of the invention, there is a computer program product including one or more computer readable storage media having program instructions collectively stored on the one or more computer readable storage media. The program instructions are executable to: receive a dataset comprising a multivariate time series that includes plural channels; generate an original forecast of the multivariate time series using a channel-independent backbone and a prediction head; and generate a revised forecast of the multivariate time series using a cross-channel reconciliation head with the original forecast, wherein the cross-channel reconciliation head generates the revised forecast based on correlations between the channels of the multivariate time series.

In another aspect of the invention, there is a system including a processor set, one or more computer readable storage media, and program instructions collectively stored on the one or more computer readable storage media. The program instructions are executable to: receive a dataset comprising a multivariate time series that includes plural channels; generate an original forecast of the multivariate time series using a channel-independent backbone and a prediction head; and generate a revised forecast of the multivariate time series using a cross-channel reconciliation head with the original forecast, wherein the cross-channel reconciliation head generates the revised forecast based on correlations between the channels of the multivariate time series.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a diagram of an exemplary operation of a forecasting server in accordance with aspects of the present invention.

FIG. 4 illustrates channel independence in accordance with aspects of the present invention.

FIG. 5 shows a functional block diagram of a hybrid channel modeling architecture in accordance with aspects of the present invention.

FIGS. 6A and 6B show an exemplary implementation of a mixer backbone in accordance with aspects of the present invention.

FIGS. 7A and 7B show an exemplary implementation of a pretrain head and a prediction head in accordance with aspects of the present invention.

FIG. 8 shows an exemplary implementation of a cross-channel reconciliation head in accordance with aspects of the present invention.

FIG. 9 shows a flowchart of an exemplary method in accordance with aspects of the present invention.

### DETAILED DESCRIPTION

Aspects of the present invention relate generally to time series forecasting using AI models and, more particularly, to hybrid channel modeling for time series foundation models. Aspects of the present invention provide effective cross-channel modelling using a hybrid channel model for timeseries foundation models. In embodiments, the hybrid channel modelling includes augmenting a channel-independent backbone with a surrounding-patch-aware cross-channel reconciliation head. Implementations of the hybrid approach enable the backbone to easily generalize across multiple datasets (with varying channels) while using the reconciliation head to effectively learn the local patch-aware channel interactions that are task and data-specific.

In embodiments, the backbone is trained in a channel-independent way. As a result, the backbone can receive different datasets with different channels.

In embodiments, the embeddings from the backbone capture a temporal correlation of the time series and also implicitly capture some amount of channel correlation via shared weights across channels.

In embodiments, the channel-independent embeddings from the backbone are fed into the cross-channel reconciliation head for explicitly capturing cross-channel correlations of a multivariate time series.

In embodiments, the cross-channel reconciliation head enables a surrounding-patch-aware cross-channel correlation. In embodiments, based on the context length, every patch takes its surrounding neighbor patches and enables a local flattening of the channels and learns cross-channel correlations in a local way.

In embodiments, the surrounding-patch-aware cross-channel correlation is executed in a local sliding window approach where the model captures the cross-channel dependencies in a local window as compared to global window (which adds more noise).

In embodiments, the cross-channel reconciliation head employs residual connections to ensure that reconciliation does not lead to accuracy drops in scenarios when the channel correlations are very noisy. In this manner, all channels of a forecast point reconcile the values based on the forecast channel values in the surrounding context, thereby leading to effective cross-channel modelling.

A transformer is a type of artificial neural network architecture that is used to solve the problem of transduction or transformation of input sequences into output sequences in deep learning applications. Examples of transformers used for time series forecasting include InFormer, AutoFormer, and FedFormer. Transformers use a self-attention algorithm that is a highly intensive computing process, and which makes transformers less than ideal for long term time series forecasting. Another shortcoming of these existing techniques is the infeasibility in adopting them as a foundation model (FM) for forecasting a time series on multiple datasets with varying numbers of channels. In particular, there is a lack of training data for training a time series FM, as opposed to natural language processing (NLP) models that have a readily available large corpus of training data.

Some transformers employ a channel-mixing approach where channels from a same patch are flattened together to create an embedding for the patch; however, these channel-mixing approaches produce noisy interactions between channels at the first layer of the transformer, and these interactions are difficult to uncouple at the output. For example, the PatchTST architecture attempts to address the above-noted challenges with channel independence; however, the model does this at the cost of removing any explicit component that can capture the cross-channel relationship.

A multilayer perceptron (MLP) mixer may be used as an alternative to a transformer for image recognition models. An MLP mixer-based architecture called TSMixer is a lightweight alternative to transformers for time series forecasting and representation learning. A backbone that uses a hierarchy patch mixer operates completely in a channel-independent approach, which means that all channels of the input multivariate time series share the same weights of the model in the backbone. This performs better than standard channel mixing techniques. However, there is still a need to explicitly model the channel interactions for opportunistic accuracy improvements, while smartly eliminating the high volume of noisy interactions across channels.

Many multivariate time series have a strong inter-channel relationship. For example, in a process industry a state variable often depends on another state variable and one or more control variables. In another example, in retail the sales are often dependent on holiday event time series, discount time series, etc. Models that do not learn cross-channel correlations essentially learn only an auto-regressive and moving average structure from the data, which limits the potential of a large foundation model to leverage its representation learning capabilities from cross-channel information.

Implementations of the invention address the above-noted problems by providing a time series forecasting model that includes a channel-independent backbone augmented with a forecasting cross-channel reconciliation head. In embodiments, the channel-independent backbone is a foundation model that is trained on multiple different time series datasets each having multiple channels. In embodiments, the channel-independent backbone receives an input dataset and generates an original forecast of the time series based on the input dataset. As used herein, channel-independent means that the layers in a model are applied across all the channels, such that all channels share the same weights of the model. A channel-independent backbone as described herein is trained using multiple different datasets and can be used to generate an original forecast of multiple different types of datasets, as opposed to being trained for use with only a single type of dataset. In accordance with aspects of the invention, the forecasting cross-channel reconciliation head receives the original forecast of the time series from the channel-independent backbone and generates a revised forecast of the time series based on the original forecast of the time series. In embodiments, the forecasting cross-channel reconciliation head is specific to a particular type of dataset. In embodiments, different forecasting cross-channel reconciliation heads are trained for use with different datasets. In embodiments, a forecasting cross-channel reconciliation head is trained with a particular type of dataset to explicitly learn cross-channel information that is used to provide a more accurate forecast (e.g., the revised forecast) in a multivariate context. In this manner, implementations of the invention provide a technical improvement in the area of model-based time series forecasting.

Implementations of the invention are necessarily rooted in computer technology. For example, the steps of (i) generating an original forecast of the multivariate time series using a channel-independent backbone with the multivariate time series and (ii) generating a revised forecast of the multivariate time series using a cross-channel reconciliation head with the original forecast are computer-based and cannot be performed in the human mind. Training and using an artificial intelligence (AI) model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Implementations of the invention may also be used in monitoring and controlling physical systems. A multivariate time series contains two or more variables. An example of a multivariate time series is times series data from plural sensors in a system such as an industrial or manufacturing system. The time series data of each respective sensor represents a respective channel of the multivariate time series. Time series forecasting as described herein can be used to predict future values of the sensor data. Actions such as adjusting the system and/or preventative maintenance actions may be performed in the industrial or manufacturing system based on the predicted future values of the sensor data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as time series forecasting code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

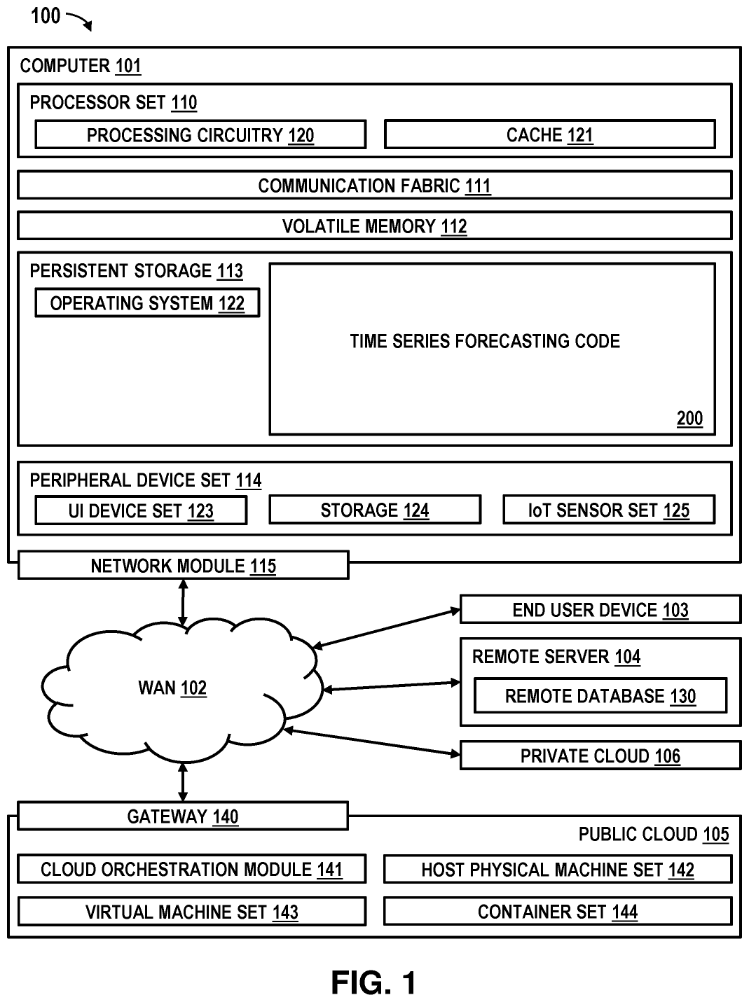

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

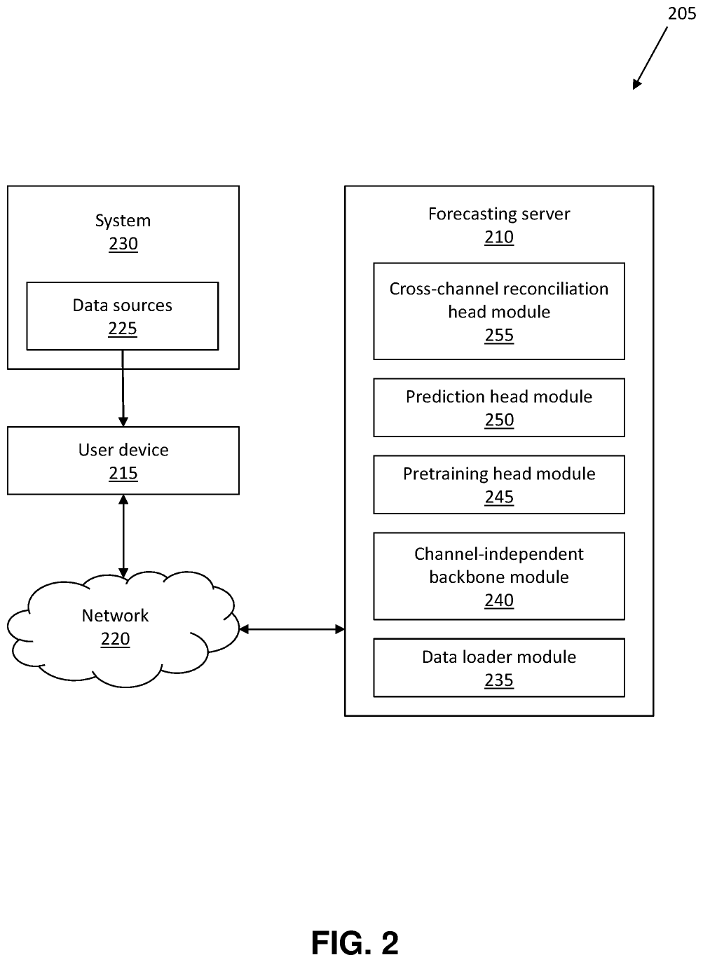

FIG. 2 shows a block diagram of an exemplary environment 205 in accordance with aspects of the invention. In embodiments, the environment 205 includes a forecasting server 210 in communication with a user device 215 via a network 220. In one example, the forecasting server 210 comprises one or more instances of the computer 101 of FIG. 1. In one example, the forecasting server 210 comprises one or more virtual machines or containers running on one or more instances of the computer 101 of FIG. 1. The user device 215 may comprise one or more instances of end user device 103 of FIG. 1. The network 220 may comprise the WAN 102 of FIG. 1.

In accordance with aspects of the invention, the user device 215 provides a multivariate time series to the forecasting server 210, and the forecasting server 210 generates and returns a forecast of the multivariate time series to the user device 215. In embodiments, the user device 215 creates the multivariate time series based on data received from data sources 225 in a system 230. In one example, the system 230 comprises an industrial or manufacturing system and the data sources 225 comprise plural sensors in the industrial or manufacturing system. In a particular non-limiting example, the system 230 comprises a concrete mixing system, and the data sources 225 comprise sensors that measure operational characteristics of the concrete mixing system, such as: mass rate of cement fed into a first mixer; mass rate, temperature, and pressure of water fed into the first mixer; mass rate of paste output from the first mixer; mass rate of sand mixed with the paste in a second mixer; and mass rate of concrete output from the second mixer. Different sensors may be used to collect data for each of the different operational characteristics, and the user device 215 may receive and store the data of each sensor as a time series for that operational characteristic. The user device 215 may provide this time series data to the forecasting server 210 and receive, in return, a forecast for the time series (e.g., a prediction of values of operational characteristics at future times). The user device 215 may make an adjustment to the concrete mixing system based on the forecast received from the forecasting server 210. For example, the forecast received from the forecasting server 210 may indicate that the mass rate of the concrete output from the second mixer will fall below a lower threshold at time t. Based on this, the user device 215 may adjust the system by increasing the mass rate of the cement, water, and sand in an attempt to increase the mass rate of the concrete output at the future time t. Embodiments are not limited to use with this particular example of a system, and are not limited to use with a system in general. Instead, embodiments may be used to generate a forecast for any multivariate time series.

In embodiments, the forecasting server 210 of FIG. 2 comprises a data loader module 235, channel-independent backbone module 240, pretraining head module 245, prediction head module 250, and cross-channel reconciliation head module 255, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The forecasting server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the data loader module 235 is configured to perform pre-processing steps on a multivariate time series. In embodiments, the pre-processing steps in a pre-training workflow comprise dividing the multivariate time series into plural univariate time series and then normalizing, patching, masking, and permuting the respective univariate time series. In embodiments, the pre-processing steps in a prediction workflow comprise dividing the multivariate time series into plural univariate time series and then normalizing, patching, and permuting the respective univariate time series.

In accordance with aspects of the invention, the channel-independent backbone module 240 comprises a time series foundation model backbone that is channel-independent. In embodiments, the channel-independent backbone module 240 receives pre-processed data from the data loader module 235 and generates an intermediate output using an AI model with the pre-processed data. In one example, the channel-independent backbone module 240 comprises a transformer such as the backbone used in the PatchTST architecture. In another example, the channel-independent backbone module 240 comprises an MLP mixer such as the backbone used in TSMixer.

In accordance with aspects of the invention, the pretraining head module 245 is configured to receive the intermediate output from the channel-independent backbone module 240, determine a loss value for the intermediate output using a loss function, and adjust one or more parameters of the AI model in the channel-independent backbone module 240 based on the loss value. In embodiments, the pretraining head module 245 is used to train the channel-independent backbone module 240 during the training workflow.

In accordance with aspects of the invention, the prediction head module 250 is configured to receive the intermediate output from the channel-independent backbone module 240 and generate an original forecast for the multivariate time series based on the intermediate output.

In accordance with aspects of the invention, the cross-channel reconciliation head module 255 is configured to receive the original forecast from the prediction head module 250 and generate a revised forecast for the multivariate time series using an AI model with the original forecast.

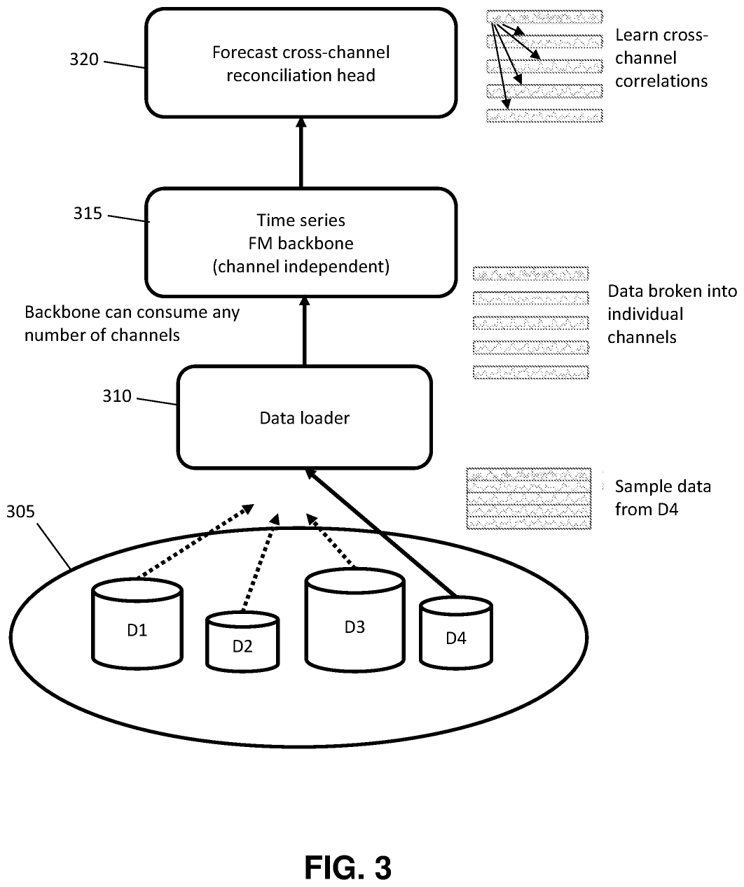

FIG. 3 shows a diagram of an exemplary operation of the forecasting server 210 of FIG. 2 in accordance with aspects of the present invention. Block 305 shows datasets D1, D2, D3, and D4. Each dataset D1-D4 comprises a multivariate time series including plural channels, where a channel denotes an individual time series in the multivariate time series. Block 310 is a data loader which performs preprocessing the data including dividing a multivariate time series into plural univariate time series. The functions of block 310 may be performed by the data loader module 235 of FIG. 2. Block 315 represents a channel-independent backbone that is trained using the all the datasets D1-D4. The functions of block 315 may be performed by the channel-independent backbone module 240 of FIG. 2. Block 320 represents a forecast cross-channel reconciliation head that learns cross-channel correlations for a particular one of the datasets D1-D4 (i.e., for dataset D4 in this example). The functions of block 320 may be performed by the cross-channel reconciliation head module 255 of FIG. 2. As demonstrated in FIG. 3, the channel-independent backbone is trained using plural different datasets and can be used to generate a prediction for each of the datasets, whereas the cross-channel reconciliation head learns correlations between channels for a particular one of the datasets D1-D4 (i.e., for dataset D4 in this example).

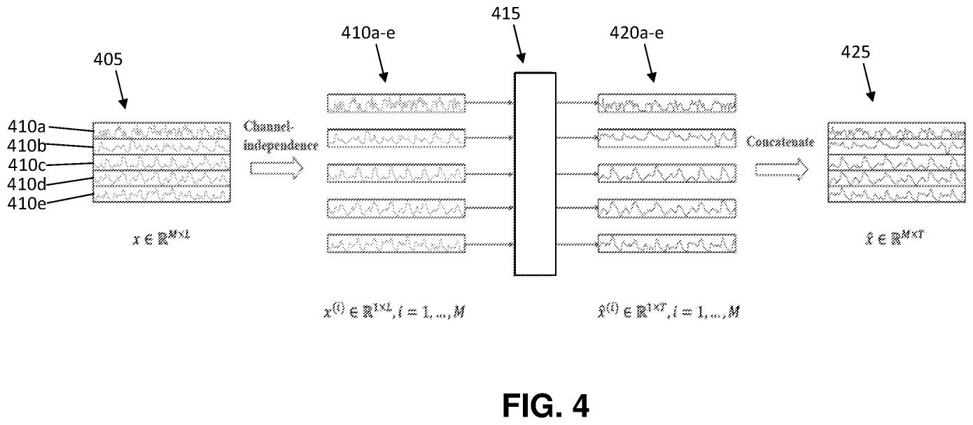

FIG. 4 illustrates channel independence in accordance with aspects of the present invention. As shown in FIG. 4, a multivariate time series 405 comprises plural univariate times series 410a-c. In embodiments, the multivariate time series 405 is decomposed into the individual univariate time series 410a-e prior to being input to the backbone 415. In the backbone 415, each of the univariate time series 410a-e shares the same model weights and the model learns an average loss across all the different univariate time series 410a-e. The output of the backbone 415 is a group of forecast univariate time series 420a-e which may be concatenated to form a forecast multivariate time series 425.

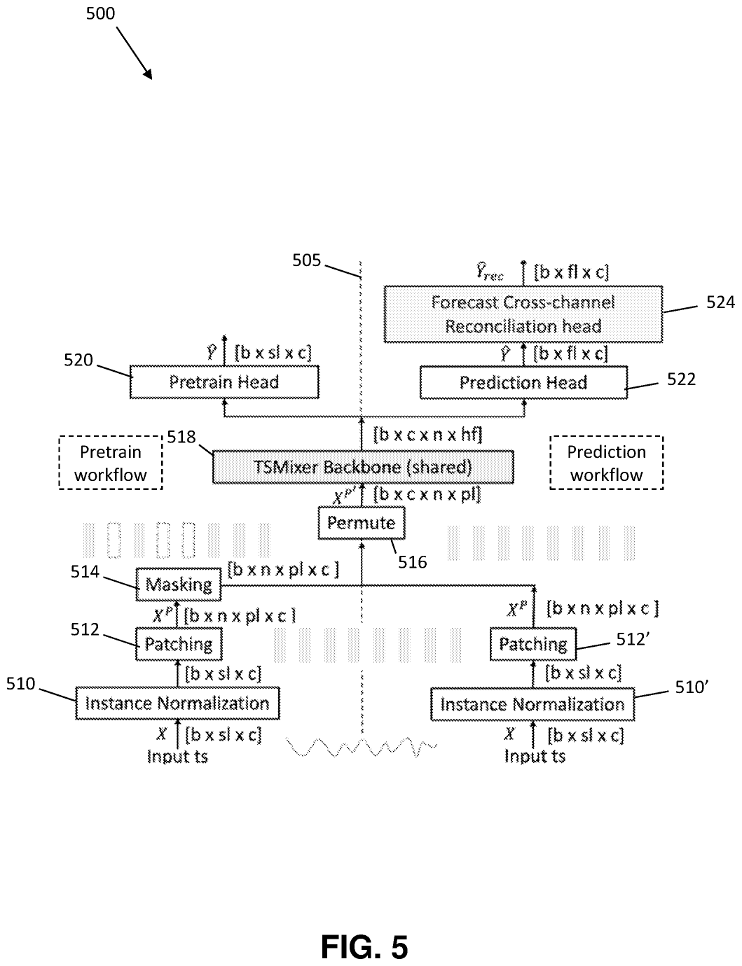

FIG. 5 shows a functional block diagram of a hybrid channel modeling architecture 500 in accordance with aspects of the present invention. The architecture disclosed herein is patching-based and follows a modular architecture of learning a common backbone to capture the temporal dynamics of the data as a patch representation, wherein different heads are attached and finetuned based on various downstream tasks (e.g., forecasting). The backbone is considered task-independent and can learn across multiple datasets with a masked reconstruction loss while the heads are task and data-specific.

A pretraining workflow of the architecture is shown to the left of line 505, and a prediction workflow of the architecture is shown to the right of line 505. In the diagram, X represents an input time series and Y represents a forecast time series. In the diagram, the following variable names are used:
b: batch size
sl: input sequence length
fl: forecast sequence length
c: number of channels
n: number of patches
pl: patch length
hf: hidden features dimension

In the pretraining workflow, an input time series X having the matrix form [b x sl x c] undergoes an instance normalization at block 510, which converts the time series to a common scale. The data undergoes patching at block 512, where patches are defined comprising groups of data points of the time series. The output of block 512 is X^{P} in the form of [b x n x pl x c], and this data undergoes masking at block 514. In the pretraining workflow, the masking comprises masking a fraction of the patches that are created at block 512 for the purpose of training the backbone to reconstruct the masked patches based on the unmasked patches. The output of block 514 is X^{P} in the form of [b x n x pl x c] with a fraction of the patches being masked and the rest being unmasked. At block 516 that data is permuted, which re-orders the shape of the data to the form of X^{P′} as [b x cx n x pl]. Still in the training workflow, at block 518 the backbone uses an AI model to generate an intermediate output having the form [b x c x n x hf]. At block 520, a pretrain head transforms the intermediate output to a training forecast Ý having the form of [b x sl x c], which is the same form at the input time series X. In embodiments, the system trains the backbone of block 518 using a loss function that is based on a difference between the training forecast Ý and a ground truth. In a particular embodiment, the system adjusts the parameters in the AI model of the backbone to minimize the mean square error (MSE) of plural sets of X and.

With continued reference to FIG. 5, the prediction workflow begins with instance normalization at block 510′ and patching at block 512′ that are performed in the same manner as blocks 510 and 512. The prediction workflow does not mask any patches. As a result, the output of block 512′ is input to the backbone at block 518, which uses the trained AI model to generate the intermediate output. At block 522, a prediction head generates an original forecast Ŷ in the form of [b x fl x c] by applying a series of functions to the intermediate output. In accordance with aspects of the invention, the forecast cross-channel reconciliation head at block 524 generates a revised forecast Ŷ_{rec} based on the original forecast Ý from the prediction head of block 522.

In embodiments, the data loader module 235 of FIG. 2 performs the functions of blocks 510, 510′, 512, 512′. 514, and 516 of FIG. 5. In embodiments, the channel-independent backbone module 240 of FIG. 2 performs the functions of block 518 of FIG. 5. In embodiments, the pretraining head module 245 of FIG. 2 performs the functions of block 520 of FIG. 5. In embodiments, the prediction head module 250 of FIG. 2 performs the functions of block 522 of FIG. 5. In embodiments, the cross-channel reconciliation head module 255 of FIG. 2 performs the functions of block 524 of FIG. 5.

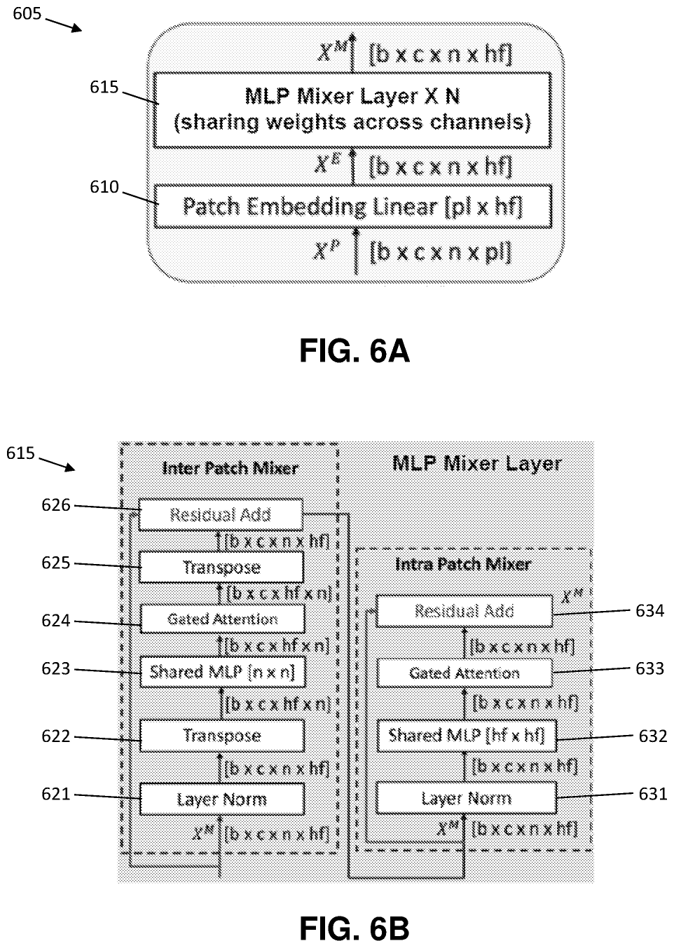

FIGS. 6A and 6B show an exemplary implementation of an MLP mixer backbone 605 in accordance with aspects of the present invention. The MLP mixer backbone 605 is one example of a channel-independent backbone that may be used as the backbone of block 518 of FIG. 5. However, an MLP mixer backbone is not the only type of backbone that may be used in embodiments. Another example, not described in detail here, is the channel-independent backbone used in the PatchTST architecture.

As shown in FIG. 6A, the MLP mixer backbone 605 may comprise a patch embedding linear layer 610 and N number of MLP mixer layers 615. In embodiments, the patch embedding linear layer 610 transforms every patch independently into an embedding: X_{b×c×n×hf}^{E}= [symbol] (X^{P′}), where [symbol] (X^{P′}), represents layers in the neural network being trained, and wherein the weight and bias of the layers are shared across channels for the backbone.

FIG. 6B shows details of one of the MLP mixer layers 615, which are configured to learn correlations across two different directions: (i) between different patches, and (ii) between the hidden feature inside a patch. The inter patch mixer module employs a shared MLP (weight dimension=n×n) to learn correlation between different patches. In embodiments, the inter patch mixer module comprises a normalization layer 621, a transpose layer 622, a shared MLP layer 623, a gated attention layer 624, a transpose layer 625, and a residual add layer 626, each of which may comprise a module as described herein. The intra patch mixer module's shared MLP layer mixes the dimensions of the hidden features, and hence the weight matrix has a dimension of hf×hf. In embodiments, the intra patch mixer module comprises a normalization layer 631, a shared MLP layer 632, a gated attention layer 633 and a residual add layer 634, each of which may comprise a module as described herein. The input and output of the mixer layers and mixer blocks are denoted by X_{b×c×n×hf}^{M}. Based on the dimension under focus in each mixer block, the input gets reshaped accordingly to learn correlation along the focused dimension. The reshape gets reverted in the end to retain the original input shape across the blocks and layers.

Time series data often includes some unimportant features that confuse the model. In order to effectively filter out these features, gated attention layers 624 and 633 are added after the shared MLP layers 623 and 632, respectively, in each mixer component of the backbone 605. Gated attention is a computer-based gating function that probabilistically upscales the dominant features and downscales the unimportant features based on its feature values. The attention weights may be derived by: W_{b×c×n×hf}^{A}=SoftMax( [symbol] (X^{M})). The output of the gated attention module is obtained by performing a dot product between the attention weights and the hidden tensor coming out of the mixer modules: X^{G}=W^{A}·X^{M}. Augmenting gated attention with standard mixer operations effectively guides the model to focus on the important features leading to improved long-term interaction modeling, without requiring the need for complex multi-head self-attention.

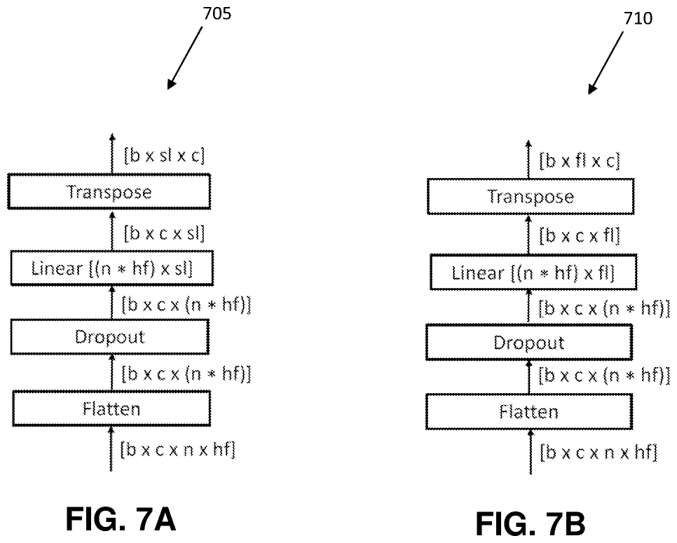

FIGS. 7A and 7B show an exemplary implementation of a pretrain head 705 and a prediction head 710 in accordance with aspects of the present invention. The pretrain head 705 may be used at block 520 of FIG. 5, and the prediction head 710 may be used at block 522 of FIG. 5.

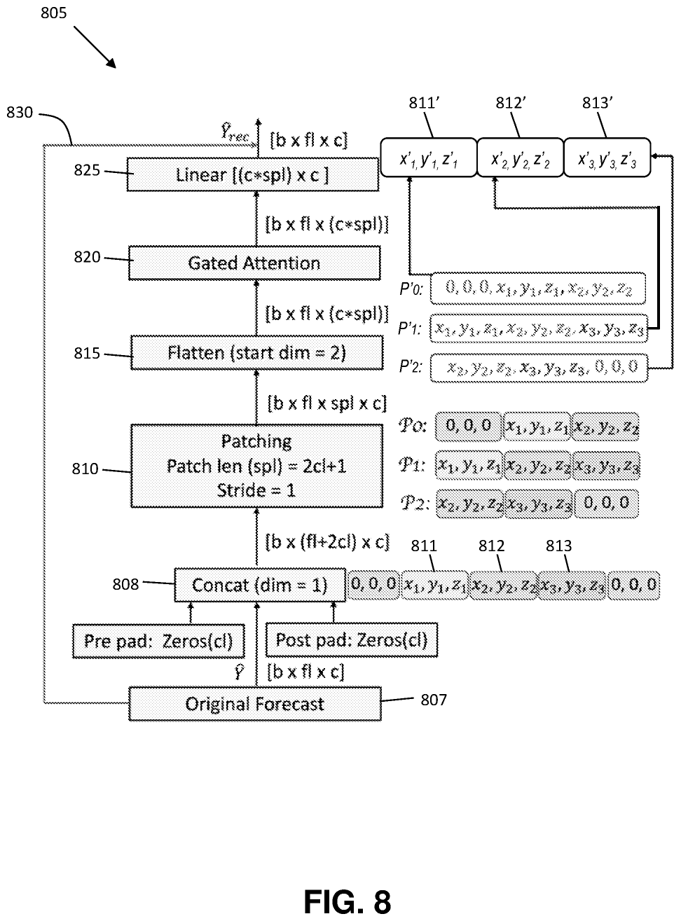

FIG. 8 shows an exemplary implementation of a cross-channel reconciliation head 805 in accordance with aspects of the present invention. The cross-channel reconciliation head 805 may be used at block 524 of FIG. 5. The cross-channel reconciliation head 805 enables a surrounding-patch-aware cross-channel correlation where, based on a context length, every patch takes its surrounding neighbor patches and enables a local flattening of the channels and learns cross-channel correlations in a local way. In the diagram, the following variable names are used:
b: batch size
sl: input sequence length
fl: forecast sequence length
c: number of channels
cl: context length
spl: patch length

At block 807, the original forecast Y in the form of [b x fl x c] is received from the prediction head of block 522 of FIG. 5. At block 808, the head concatenates the individual points of the original forecast. In this example, the original forecast includes point 811 that includes x₁ (which is a forecast value for channel x at future time t₁), y₁ (which is a forecast value for channel y at future time t₁), and z₁ (which is a forecast value for channel z at future time t₁). In this example, the original forecast includes point 812 that includes x₂ (which is a forecast value for channel x at future time t₂), y₂ (which is a forecast value for channel y at future time t₂), and z₂ (which is a forecast value for channel z at future time t₂). In this example, the original forecast includes point 813 that includes x₃ (which is a forecast value for channel x at future time t₃), y₃ (which is a forecast value for channel y at future time t₃), and z₃ (which is a forecast value for channel z at future time t₃). In this example, at block 808 the head concatenates these points 811-813 and adds a pre-pad set of zeros to the beginning and a and a post-pad set of zeros to the end of the concatenation.

At block 810, the head creates patches from the concatenation according to the patch length and stride, where the patch length spl is based on a context length cl. In this manner, each forecast point is converted into a patch of patch length spl by appending its pre- and post-surrounding forecasts based on a context length. In this example, patch P0 includes the pre-pad set of zeros, point 811, and point 812. In this example, patch P1 includes point 811, point 812, and point 813. In this example, patch P2 includes point 812, and point 813, and the post-pad set of zeros.

At block 815, the patches are flattened across the channels to create flattened patches. In this example, the flattened patches include P′0, P′1, and P′2. At blocks 820 and 825, the flattened patches are passed through a gated attention layer and a linear layer. In embodiments, the gated attention layer includes a matrix multiplication, followed by a SoftMax function, followed by a dot product. In embodiments, the linear layer converts the output of the gated attention layer to the revised forecast Ŷrec in form of form of [b x fl x c]. In this example, the revised forecast Ýrec includes point 811′ that includes x′/(which is a revised forecast value for channel x at future time t₁), y′₁ (which is a revised forecast value for channel y at future time t₁), and z′₁ (which is a revised forecast value for channel z at future time t₁). In this example, the revised forecast Ýrec includes point 812′ that includes x′₂ (which is a revised forecast value for channel x at future time t₂), y′₂ (which is a revised forecast value for channel y at future time t₂), and z′₂ (which is a revised forecast value for channel z at future time t₂). In this example, the revised forecast Ŷrec includes point 813′ that includes x′3 (which is a revised forecast value for channel x at future time t₃), y′₃ (which is a revised forecast value for channel y at future time t₃), and z′₃ (which is a revised forecast value for channel z at future time t₃). In this manner, each channel of a forecast point reconciles its values based on the forecast channel values in the surrounding context leading to effective cross-channel modelling.

As shown at line 830, the head 805 uses residual connections to ensure that reconciliation does not lead to accuracy drops in scenarios when the channel correlations are very noisy. Since the revised forecasts have the same dimension as the original forecasts, no change to the loss function is required.

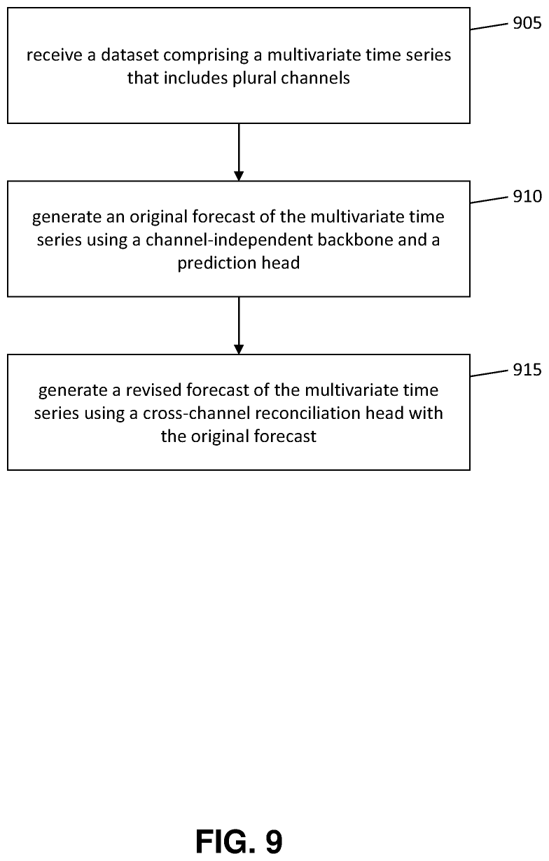

FIG. 9 shows a flowchart of an exemplary method in accordance with aspects of the present invention. Steps of the method may be carried out in the environment of FIG. 2 and are described with reference to elements depicted in FIG. 2.

At step 905, the system receives a dataset comprising a multivariate time series that includes plural channels. In embodiments, and as described with respect to FIG. 2, the data loader module 235 receives a multivariate time series, e.g., from user device 215. In one example, the multivariate time series comprises plural channels where each channel represents a univariate time series of data from one of plural data sources 225. In a particular example, the data sources 225 comprises respective sensors and the multivariate time series includes a plural univariate times comprising a respective time series from each of the respective sensors.

At step 910, the system generates an original forecast of the multivariate time series using a channel-independent backbone and a prediction head. In embodiments, and as described with respect to FIG. 2, the channel independent backbone module 240 generates an intermediate result based on the multivariate time series from step 905, and the prediction head module 250 generates an original forecast based on the intermediate result.

At step 915, the system generates a revised forecast of the multivariate time series using a cross-channel reconciliation head with the original forecast. In embodiments, and as described with respect to FIG. 2, the cross-channel reconciliation head module 255 generates the revised forecast based on the original forecast from step 910. In embodiments, and as described with respect to FIG. 8, the cross-channel reconciliation head (e.g., implemented using the cross-channel reconciliation head module 255) generates the revised forecast based on correlations between the channels of the multivariate time series.

In embodiments, the method includes the cross-channel reconciliation head creating plural patches (e.g., P0, P1, P2). In embodiments, respective ones of the patches comprise: a respective forecast point of the original forecast; and a context-length number of surrounding forecast points of the original forecast before and after the respective forecast point of the original forecast.

In embodiments, the method includes the cross-channel reconciliation head creating flattened patches (e.g., P′0, P′1, P′2) by flattening the patches across the channels of the multivariate time series.

In embodiments, the method includes the cross-channel reconciliation head generating respective revised forecast points (e.g., 811′, 812′, 813′) of the revised forecast (e.g., Ŷrec) by applying a gated attention function to respective ones of the flattened patches.

In embodiments of the method, the cross-channel reconciliation head comprises a residual connection.

In embodiments of the method, the channel-independent backbone comprises a transformer-based backbone. For example, the channel-independent backbone (e.g., implemented using the channel-independent backbone module 240) may comprise a transformer such as the backbone used in the PatchTST architecture.

In embodiments of the method, the channel-independent backbone comprises a mixer-based backbone. For example, the channel-independent backbone (e.g., implemented using the channel-independent backbone module 240) may comprise an MLP mixer such as the backbone used in TSMixer.

In embodiments of the method, the mixer-based backbone comprises a deep learning neural network model.

In embodiments, the method further comprises training the channel-independent backbone using multiple different datasets. The training may be performed using a training head, e.g., as described herein. In embodiments, the training may comprise masking a subset of patches, generating a prediction of the masked patches, applying a loss function, and adjusting values of weights of a model in the backbone via backpropagation or stochastic gradient descent.

In embodiments of the method, the multivariate time series comprises sensor data from plural sensors in a system, and the method further comprises performing an action in the system based on the revised forecast of the multivariate time series. The action may comprise adjusting one or more operational aspects of the system and/or performing preventative maintenance, e.g., as described herein.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of time series forecasting, comprising:
receiving, by a processor set, a dataset comprising a multivariate time series that includes plural channels;
generating, by the processor set, an original forecast of the multivariate time series using a channel-independent backbone and a prediction head; and
generating, by the processor set, a revised forecast of the multivariate time series using a cross-channel reconciliation head with the original forecast, wherein the cross-channel reconciliation head generates the revised forecast based on correlations between the channels of the multivariate time series.

2. The computer-implemented method of claim 1, wherein the cross-channel reconciliation head creates plural patches, wherein respective ones of the patches comprise: a respective forecast point of the original forecast; and a context-length number of surrounding forecast points of the original forecast before and after the respective forecast point of the original forecast.

3. The computer-implemented method of claim 2, wherein the cross-channel reconciliation head creates flattened patches by flattening the patches across the channels of the multivariate time series.

4. The computer-implemented method of claim 3, wherein the cross-channel reconciliation head generates respective revised forecast points of the revised forecast by applying a gated attention function to respective ones of the flattened patches.

5. The computer-implemented method of claim 2, wherein the cross-channel reconciliation head comprises a residual connection.

6. The computer-implemented method of claim 1, wherein the channel-independent backbone comprises a transformer-based backbone.

7. The computer-implemented method of claim 1, wherein the channel-independent backbone comprises a mixer-based backbone.

8. The computer-implemented method of claim 7, wherein the mixer-based backbone comprises a deep learning neural network model.

9. The computer-implemented method of claim 1, further comprising training the channel-independent backbone using multiple different datasets.

10. The computer-implemented method of claim 1, wherein the multivariate time series comprises sensor data from plural sensors in a system, and further comprising performing an action in the system based on the revised forecast of the multivariate time series.

11. A computer program product comprising one or more computer readable storage media having program instructions collectively stored on the one or more computer readable storage media, the program instructions executable to:
receive a dataset comprising a multivariate time series that includes plural channels;
generate an original forecast of the multivariate time series using a channel-independent backbone and a prediction head; and
generate a revised forecast of the multivariate time series using a cross-channel reconciliation head with the original forecast, wherein the cross-channel reconciliation head generates the revised forecast based on correlations between the channels of the multivariate time series.

12. The computer program product of claim 11, wherein the cross-channel reconciliation head creates plural patches, wherein respective ones of the patches comprise: a respective forecast point of the original forecast; and a context-length number of surrounding forecast points of the original forecast before and after the respective forecast point of the original forecast.

13. The computer program product of claim 12, wherein the cross-channel reconciliation head creates flattened patches by flattening the patches across the channels of the multivariate time series.

14. The computer program product of claim 13, wherein the cross-channel reconciliation head generates respective revised forecast points of the revised forecast by applying a gated attention function to respective ones of the flattened patches.

15. The computer program product of claim 12, wherein the cross-channel reconciliation head comprises a residual connection.

16. A system comprising:
a processor set, one or more computer readable storage media, and program instructions collectively stored on the one or more computer readable storage media, the program instructions executable to:
receive a dataset comprising a multivariate time series that includes plural channels;
generate an original forecast of the multivariate time series using a channel-independent backbone and a prediction head; and
generate a revised forecast of the multivariate time series using a cross-channel reconciliation head with the original forecast, wherein the cross-channel reconciliation head generates the revised forecast based on correlations between the channels of the multivariate time series.

17. The system of claim 16, wherein the cross-channel reconciliation head creates plural patches, wherein respective ones of the patches comprise: a respective forecast point of the original forecast; and a context-length number of surrounding forecast points of the original forecast before and after the respective forecast point of the original forecast.

18. The system of claim 17, wherein the cross-channel reconciliation head creates flattened patches by flattening the patches across the channels of the multivariate time series.

19. The system of claim 18, wherein the cross-channel reconciliation head generates respective revised forecast points of the revised forecast by applying a gated attention function to respective ones of the flattened patches.

20. The system of claim 17, wherein the cross-channel reconciliation head comprises a residual connection.
